(19) United States
(12) Patent Application Publication
(10) Pub. No.: US 2025/0008107 A1
(43) Pub. Date: Jan. 2, 2025

(54) METHODS AND DEVICES ON PROBABILITY CALCULATION FOR CONTEXT- BASED ADAPTIVE BINARY ARITHMETIC CODING

(71) Applicant: BEIJING DAJIA INTERNET INFORMATION TECHNOLOGY CO., LTD., Beijing (CN)

(72) Inventors: Xiaoyu XIU, San Diego, CA (US); Yi-Wen CHEN, San Diego, CA (US); Wei CHEN, San Diego, CA (US); Han GAO, San Diego, CA (US); Che-Wei KUO, San Diego, CA (US); Hong-Jheng JHU, San Diego, CA (US); Ning YAN, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 18/885,498

(22) Filed: Sep. 13, 2024

Related U.S. Application Data
(63) Continuation of application No. PCT/US2023/015317, filed on Mar. 15, 2023.
(60) Provisional application No. 63/320,209, filed on Mar. 15, 2022.

(51) Int. Cl. H04N 19/13; H04N 19/184; H04N 19/196

(52) U.S. Cl. CPC H04N 19/13; H04N 19/184; H04N 19/196

(57) ABSTRACT

Methods for video decoding and encoding, apparatuses and non-transitory computer-readable storage media thereof are provided. In one method for video decoding, a binary arithmetic decoder may obtain a first probability for a binary symbol according to a first adaptation parameter, where the binary symbol is related to one given context model for the binary arithmetic decoder and the binary symbol is from a plurality of binary symbols associated with the context model. Furthermore, the decoder may obtain a second probability for the binary symbol according to a second adaptation parameter, and then obtain a multi-hypothesis probability according to the first probability, a first adaptive weight, the second probability, and a second adaptive weight, where the multi-hypothesis probability determines a probability of the binary symbol equaling to a binary value. Moreover, the decoder may decode the binary symbol according to the multi-hypothesis probability.

### CROSS-REFERENCE TO RELATED APPLICATION

The present application is a continuation of PCT Application PCT/US2023/015317 filed on Mar. 15, 2023, which is based on and claims the benefit of U.S. Provisional Application No. 63/320,209, entitled “Probability Calculation for Context-Based Adaptive Binary Arithmetic Coding,” filed on Mar. 15, 2022, both disclosures of which are incorporated by reference in their entireties for all purposes.

### TECHNICAL FIELD

The present disclosure is related to video coding and compression, and in particular but not limited to, methods and apparatus on improving the accuracy of probability estimation module for the context-based adaptive binary arithmetic coding (CABAC) that is the entropy coding method used for modern video codecs.

### BACKGROUND

Various video coding techniques may be used to compress video data. Video coding is performed according to one or more video coding standards. For example, video coding standards include versatile video coding (VVC), high-efficiency video coding (H.265/HEVC), advanced video coding (H.264/AVC), moving picture expert group (MPEG) coding, or the like. Video coding generally utilizes prediction methods (e.g., inter-prediction, intra-prediction, or the like) that take advantage of redundancy present in video images or sequences. An important goal of video coding techniques is to compress video data into a form that uses a lower bit rate, while avoiding or minimizing degradations to video quality.

The first version of the VVC standard was finalized in July, 2020, which offers approximately 50% bit-rate saving or equivalent perceptual quality compared to the prior generation video coding standard HEVC. Although the VVC standard provides significant coding improvements than its predecessor, there is evidence that superior coding efficiency can be achieved with additional coding tools. Recently, Joint Video Exploration Team (JVET) under the collaboration of ITU-T VECG and ISO/IEC MPEG started the exploration of advanced technologies that can enable substantial enhancement of coding efficiency over VVC. In April 2021, one software codebase, called Enhanced Compression Model (ECM) was established for future video coding exploration work. The ECM reference software was based on VVC Test Model (VTM) that was developed by JVET for the VVC, with several existing modules (e.g., intra/inter prediction, transform, in-loop filter and so forth) are further extended and/or improved. In future, any new coding tool beyond the VVC standard need to be integrated into the ECM platform, and tested using JVET common test conditions (CTCs).

### SUMMARY

The present disclosure provides examples of techniques relating to improving the accuracy of probability estimation module for the CABAC.

According to a first aspect of the present disclosure, there is provided a method for video decoding. The method includes that one binary arithmetic decoder may obtain a first probability for a binary symbol according to a first adaptation parameter, where the binary symbol is related to a given context model for the binary arithmetic decoder and the binary symbol is one of a plurality of binary symbols associated with the context model. Furthermore, the decoder may obtain a second probability for the binary symbol according to a second adaptation parameter, and then obtain a multi-hypothesis probability for the binary symbol according to the first probability, a first adaptive weight, the second probability, and a second adaptive weight, where the multi-hypothesis probability for the binary symbol is determined as a binary value. Moreover, the decoder may decode the binary symbol according to the multi-hypothesis probability.

According to a second aspect of the present disclosure, there is provided a method for video encoding. The method includes that one binary arithmetic encoder may obtain a first probability for one binary symbol according to a first adaptation parameter, where the one binary symbol is related to one given context model for the binary arithmetic encoder and the one binary symbol is from a plurality of binary symbols associated with the context model. Furthermore, the encoder may obtain a second probability for the one binary symbol according to a second adaptation parameter and then obtain a multi-hypothesis probability according to the first probability, a first adaptive weight, the second probability, and a second adaptive weight, where the multi-hypothesis probability determines a probability of the one binary symbol equaling to a binary value. Moreover, the encoder may encode the one binary symbol according to the multi-hypothesis probability.

According to a third aspect of the present disclosure, there is provided a method for video decoding. The method includes that a decoder may select a fixed position from a slice that is decoded prior to a current slice and obtain stored context states by storing context states of one or more context models and use the stored context states as initial context states of corresponding context models of one or more following slices in response to determining that decoding a coding block that covers the fixed position has finished.

According to a fourth aspect of the present disclosure, there is provided a method for video encoding. The method includes that an encoder may select a fixed position from a slice that is encoded prior to a current slice and obtain stored context states by storing context states of one or more context models and use the stored context states as initial context states of corresponding context models of one or more following slices.

According to a fifth aspect of the present disclosure, there is provided an apparatus for video decoding. The apparatus includes one or more processors and a memory coupled to the one or more processors and configured to store instructions executable by the one or more processors, where the one or more processors, upon execution of the instructions, are configured to perform the method according to the first or third aspect.

According to a sixth aspect of the present disclosure, there is provided an apparatus for video encoding. The apparatus includes one or more processors and a memory coupled to the one or more processors and configured to store instructions executable by the one or more processors, where the one or more processors, upon execution of the instructions, are configured to perform the method according to the second or fourth aspect.

According to a seventh aspect of the present disclosure, there is provided a non-transitory computer-readable storage medium for storing computer-executable instructions that, when executed by one or more computer processors, cause the one or more computer processors to receive a bitstream, and perform the method according to the first or third aspect based on the bitstream.

According to an eight aspect of the present disclosure, there is provided a non-transitory computer-readable storage medium for storing computer-executable instructions that, when executed by one or more computer processors, cause the one or more computer processors to perform the method according to the second or fourth aspect to encode the current slice into a bitstream, and transmit the bitstream.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1A is a block diagram illustrating a system for encoding and decoding video blocks in accordance with some examples of the present disclosure.

FIG. 1B is a block diagram of an encoder in accordance with some examples of the present disclosure.

FIGS. 1C-1F are block diagrams illustrating how a frame is recursively partitioned into multiple video blocks of different sizes and shapes in accordance with some examples of the present disclosure.

FIG. 1G is a block diagram illustrating an exemplary video encoder in accordance with some examples of the present disclosure

FIG. 2A is a block diagram of a decoder in accordance with some examples of the present disclosure.

FIG. 2B is a block diagram illustrating an exemplary video decoder in accordance with some examples of the present disclosure.

FIG. 3A is a diagram illustrating block partitions in a multi-type tree structure in accordance with some examples of the present disclosure.

FIG. 3B is a diagram illustrating block partitions in a multi-type tree structure in accordance with some examples of the present disclosure.

FIG. 3C is a diagram illustrating block partitions in a multi-type tree structure in accordance with some examples of the present disclosure.

FIG. 3D is a diagram illustrating block partitions in a multi-type tree structure in accordance with some examples of the present disclosure.

FIG. 3E is a diagram illustrating block partitions in a multi-type tree structure in accordance with some examples of the present disclosure.

FIG. 4 is a diagram illustrating a computing environment coupled with a user interface in accordance with some examples of the present disclosure.

FIG. 5 is a flow chart illustrating a method for video decoding in accordance with some examples of the present disclosure.

FIG. 6 is a flow chart illustrating a method for video encoding corresponding to the method for video decoding as shown in FIG. 5 in accordance with some examples of the present disclosure.

FIG. 7 is a flow chart illustrating a method for video decoding in accordance with some examples of the present disclosure.

FIG. 8 is a flow chart illustrating a method for video encoding corresponding to the method for video decoding as shown in FIG. 7 in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Terms used in the disclosure are only adopted for the purpose of describing specific embodiments and not intended to limit the disclosure. “A/an,” “said,” and “the” in a singular form in the disclosure and the appended claims are also intended to include a plural form, unless other meanings are clearly denoted throughout the disclosure. It is also to be understood that term “and/or” used in the disclosure refers to and includes one or any or all possible combinations of multiple associated items that are listed.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g., devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

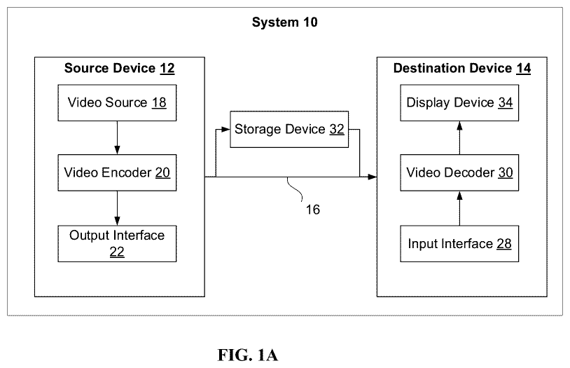

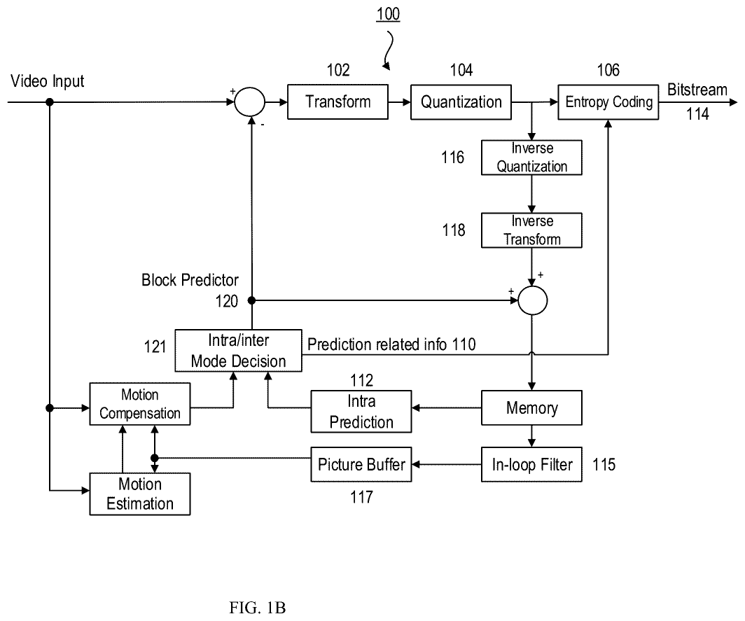

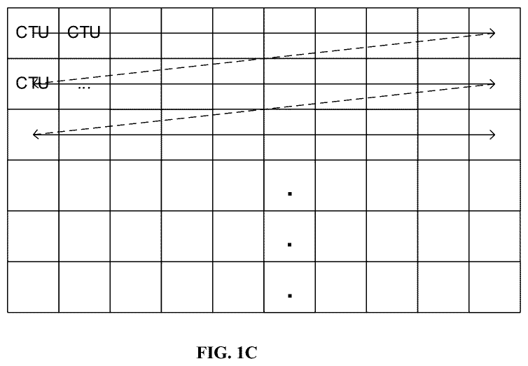

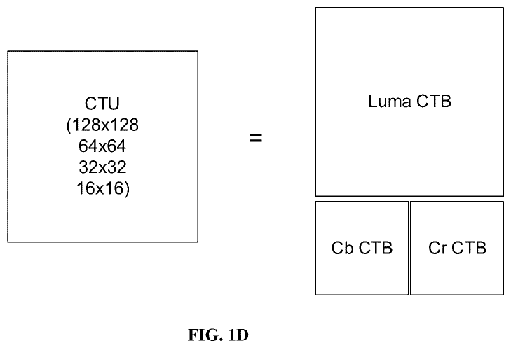

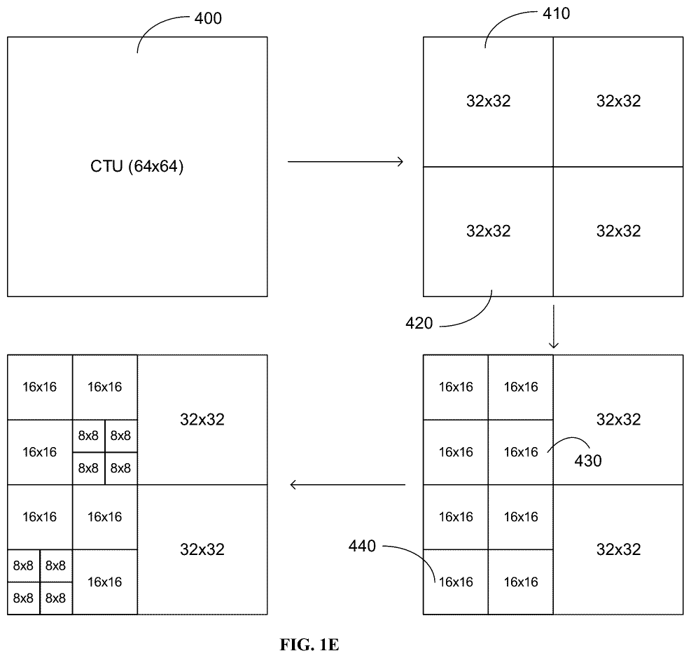

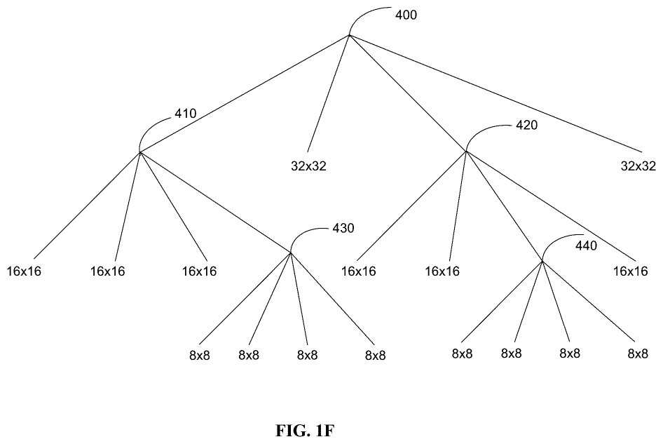

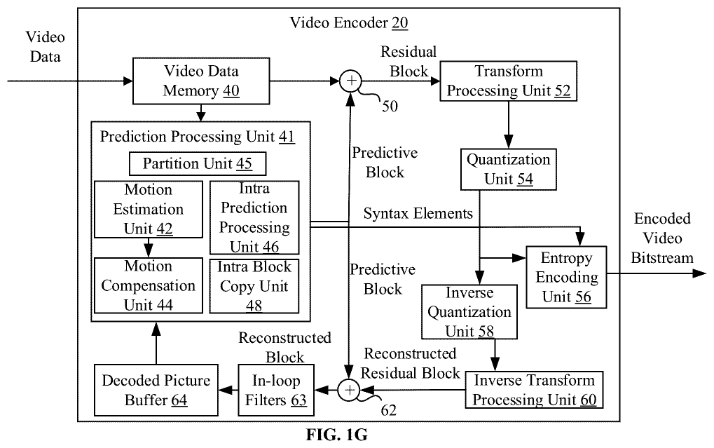

FIG. 1A is a block diagram illustrating an exemplary system 10 for encoding and decoding video blocks in parallel in accordance with some implementations of the present disclosure. As shown in FIG. 1A, the system 10 includes a source device 12 that generates and encodes video data to be decoded at a later time by a destination device 14. The source device 12 and the destination device 14 may include any of a wide variety of electronic devices, including desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may include any type of communication medium or device capable of moving the encoded video data from the source device 12 to the destination device 14. In one example, the link 16 may include a communication medium to enable the source device 12 to transmit the encoded video data directly to the destination device 14 in real time. The encoded video data may be modulated according to a communication standard, such as a wireless communication protocol, and transmitted to the destination device 14. The communication medium may include any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1A, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may include any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

Like HEVC, VVC is built upon the block-based hybrid video coding framework. FIG. 1B is a block diagram illustrating a block-based video encoder in accordance with some implementations of the present disclosure. In the encoder 100, the input video signal is processed block by block, called coding units (CUs). The encoder 100 may be the video encoder 20 as shown in FIG. 1A. In VTM-1.0, a CU can be up to 128×128 pixels. However, different from the HEVC which partitions blocks only based on quad-trees, in VVC, one coding tree unit (CTU) is split into CUs to adapt to varying local characteristics based on quad/binary/ternary-tree. Additionally, the concept of multiple partition unit type in the HEVC is removed, i.e., the separation of CU, prediction unit (PU) and transform unit (TU) does not exist in the VVC anymore; instead, each CU is always used as the basic unit for both prediction and transform without further partitions. In the multi-type tree structure, one CTU is firstly partitioned by a quad-tree structure. Then, each quad-tree leaf node can be further partitioned by a binary and ternary tree structure.

FIGS. 3A-3E are schematic diagrams illustrating multi-type tree splitting modes in accordance with some implementations of the present disclosure. FIGS. 3A-3E respectively show five splitting types including quaternary partitioning (FIG. 3A), vertical binary partitioning (FIG. 3B), horizontal binary partitioning (FIG. 3C), vertical ternary partitioning (FIG. 3D), and horizontal ternary partitioning (FIG. 3E).

For each given video block, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes.

After spatial and/or temporal prediction, an intra/inter mode decision circuitry 121 in the encoder 100 chooses the best prediction mode, for example based on the rate-distortion optimization method. The block predictor 120 is then subtracted from the current video block; and the resulting prediction residual is de-correlated using the transform circuitry 102 and the quantization circuitry 104. The resulting quantized residual coefficients are inverse quantized by the inverse quantization circuitry 116 and inverse transformed by the inverse transform circuitry 118 to form the reconstructed residual, which is then added back to the prediction block to form the reconstructed signal of the CU. Further, in-loop filtering 115, such as a deblocking filter, a sample adaptive offset (SAO), and/or an adaptive in-loop filter (ALF) may be applied on the reconstructed CU before it is put in the reference picture store of the picture buffer 117 and used to code future video blocks. To form the output video bitstream 114, coding mode (inter or intra), prediction mode information, motion information, and quantized residual coefficients are all sent to the entropy coding unit 106 to be further compressed and packed to form the bit-stream.

For example, a deblocking filter is available in AVC, HEVC as well as the now-current version of VVC. In HEVC, an additional in-loop filter called SAO is defined to further improve coding efficiency. In the now-current version of the VVC standard, yet another in-loop filter called ALF is being actively investigated, and it has a good chance of being included in the final standard.

These in-loop filter operations are optional. Performing these operations helps to improve coding efficiency and visual quality. They may also be turned off as a decision rendered by the encoder 100 to save computational complexity.

It should be noted that intra prediction is usually based on unfiltered reconstructed pixels, while inter prediction is based on filtered reconstructed pixels if these filter options are turned on by the encoder 100.

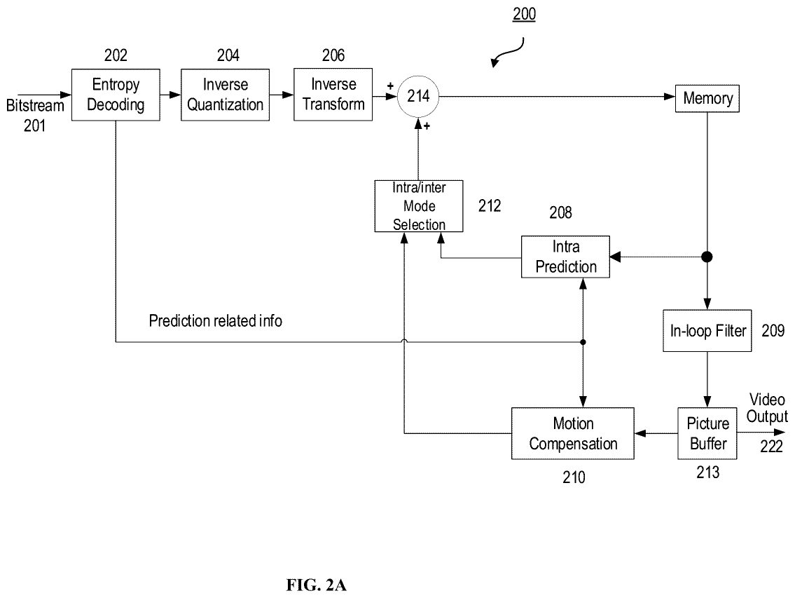

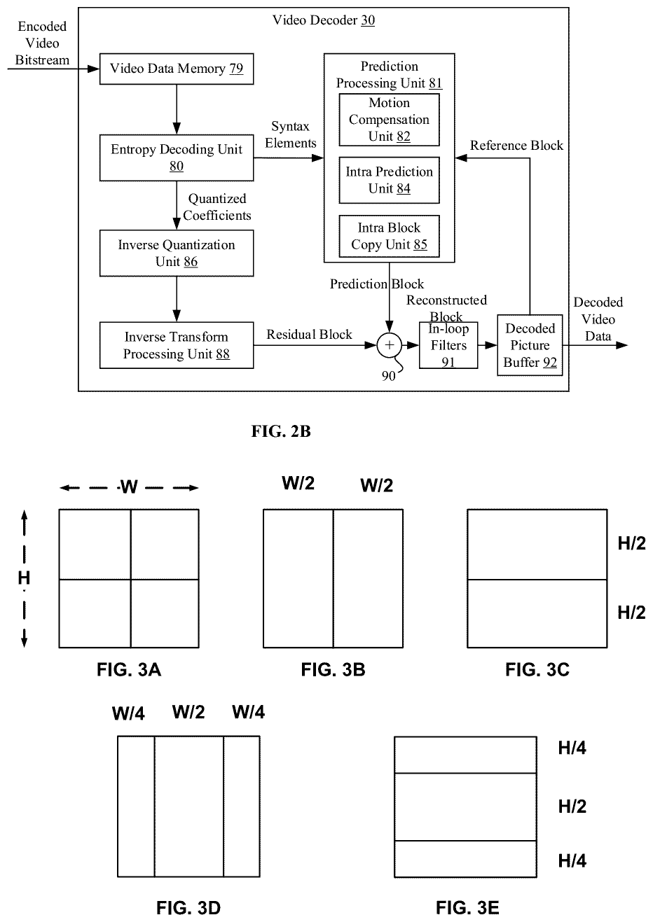

FIG. 2A is a block diagram illustrating a block-based video decoder 200 which may be used in conjunction with many video coding standards. This decoder 200 is similar to the reconstruction-related section residing in the encoder 100 of FIG. 1B. The block-based video decoder 200 may be the video decoder 30 as shown in FIG. 1A. In the decoder 200, an incoming video bitstream 201 is first decoded through an Entropy Decoding 202 to derive quantized coefficient levels and prediction-related information. The quantized coefficient levels are then processed through an Inverse Quantization 204 and an Inverse Transform 206 to obtain a reconstructed prediction residual. A block predictor mechanism, implemented in an Intra/inter Mode Selector 212, is configured to perform either an Intra Prediction 208, or a Motion Compensation 210, based on decoded prediction information. A set of unfiltered reconstructed pixels are obtained by summing up the reconstructed prediction residual from the Inverse Transform 206 and a predictive output generated by the block predictor mechanism, using a summer 214.

The reconstructed block may further go through an In-Loop Filter 209 before it is stored in a Picture Buffer 213 which functions as a reference picture store. The reconstructed video in the Picture Buffer 213 may be sent to drive a display device, as well as used to predict future video blocks. In situations where the In-Loop Filter 209 is turned on, a filtering operation is performed on these reconstructed pixels to derive a final reconstructed Video Output 222.

FIG. 1G is a block diagram illustrating another exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 1G, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter and/or Adaptive in-Loop Filter (ALF), may also be used in addition to the deblocking filter to filter an output of the summer 62. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1A. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 1G, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g., a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1A, or archived in the storage device 32 as shown in FIG. 1A for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 2B is a block diagram illustrating another exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 1G. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 2B. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1A.

In the current VVC and AVS3 standards, motion information of the current coding block is either copied from spatial or temporal neighboring blocks specified by a merge candidate index or obtained by explicit signaling of motion estimation. The focus of the present disclosure is to improve the accuracy of the motion vectors for affine merge mode by improving the derivation methods of affine merge candidates. To facilitate the description of the present disclosure, the existing affine merge mode design in the VVC standard is used as an example to illustrate the proposed ideas. Please note that though the existing affine mode design in the VVC standard is used as the example throughout the present disclosure, to a person skilled in the art of modern video coding technologies, the proposed technologies can also be applied to a different design of affine motion prediction mode or other coding tools with the same or similar design spirit.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

As shown in FIG. 1C, the video encoder 20 (or more specifically a partition unit in a prediction processing unit of the video encoder 20) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 1D, each CTU may include one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may include a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 1E, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 1F depicts a quad-tree data structure illustrating the end result of the partition process of the CTU 400 as depicted in FIG. 1E, each leaf node of the quad-tree corresponding to one CU of a respective size ranging from 32×32 to 8×8. Like the CTU depicted in FIG. 1D, each CU may include a CB of luma samples and two corresponding coding blocks of chroma samples of a frame of the same size, and syntax elements used to code the samples of the coding blocks. In monochrome pictures or pictures having three separate color planes, a CU may include a single coding block and syntax structures used to code the samples of the coding block. It should be noted that the quad-tree partitioning depicted in FIGS. 1E-1F is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIGS. 3A-3E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may include a PB of luma samples, two corresponding PBs of chroma samples, and syntax elements used to predict the PBs. In monochrome pictures or pictures having three separate color planes, a PU may include a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 1E, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may include a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may include a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit as described above in connection with FIG. 1B, the motion vector predictor of the current CU is subtracted from the actual motion vector of the current CU to produce a Motion Vector Difference (MVD) for the current CU. By doing so, there is no need to encode the motion vector determined by the motion estimation unit for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

The main goal of the disclosure is to enhance the efficiency of the CABAC techniques that are used in hybrid video coding framework. Specifically, several improvements are proposed to increase the accuracy of the probability estimation for the serial of binary symbols (also known as bins in short) of syntax elements that are generated when compressing video signal. In the following, in-depth analysis of the existing CABAC techniques that are applied in the modern video coding standards, such as AVC, HEVC and VVC, are firstly provided. Then, some deficiencies/limitations in the existing CABAC design are discussed. After that, methods are proposed for improved CABAC efficiency through increasing the accuracy of the probability estimation.

### The Probability Estimation Technique for the CABAC in the AVC and HEVC

The CABAC was originally introduced in the H.264/AVC standard, as one of two supported entropy coding schemes. In the CABAC, arithmetic coding is composed of two modules: codeword mapping (also known as binarization) and probability estimation. In the process of codeword mapping, the syntax elements are mapped into strings of bins. The mapping is realized by the so-called binarizer which translates the syntax elements into several group of bins based on different binarization schemes. In practice, various binarization schemes may be applied for such translation, such as fixed-length code, unary code, truncated unary code, and kth-order Exponential-Golomb code and so forth. The purpose of the probability estimation module is to determine the likelihood of one bin having the value of 1 or 0. In the AVC, the probabilities of bins are calculated based on an exponential aging model, where the probability that one current bin is equal to 1 or 0 is dependent on the values of previous bins that are previously coded. Additionally, according to common data statistics, the influence of bins that are immediately precede one current bin are usually larger than the bins that are coded long ago. Taking such into consideration, one parameter α is introduced in the CABAC, which controls the number N of previously coded bins that are used to estimate the probability of the current bin, i.e., N=1/α. The parameter translates into the adaptation speed with which the probability is updated along with the increased coded bins. Specifically, with the adaptation parameter α, the probability that one bin is the least probable symbol (LPS) is calculated recursively as

$$p ( t + 1 ) = p ( t ) \cdot ( 1 - α ) + x ( t ) \cdot α \qquad ( 1 )$$

where p(t) is the probability of the LPS symbol at instant t; p(t+1) is the updated probability of the LPS symbol at instant t+1; x(t) is equal to 1 when the current bin is LPS symbol and 0 when the current bin is the most probable symbol (MPS). In the CABAC engine of the AVC and the HEVC, the probability is independently updated according to (1) for each syntax element with a fixed value of α≈1/19.69, i.e., around 19.69 previously coded bins are considered when estimating the probability of one current bin. Moreover, in order to avoid multiplications during the probability estimation, the probability p(t) in equation (1), which is real number and ranges from 0 to 1, is quantized into a set of fixed probability states. For example, in both the AVC and the HEVC, the probability has 7-bit precision, corresponding to 128 probability states.

In the AVC and the HEVC, a video bitstream usually consists one or more independently decodable slices. At beginning of each slice, the probabilities of all the contexts are initialized to some pre-defined values. Theoretically, with knowing the statistic nature of one given context, uniform distribution (i.e., pᵢₙᵢₜ=0.5) should be used to initialize the context probability. However, to enable a faster catchup of the probability of one context to its corresponding statistical distribution, it was found that to be beneficial to provide some appropriate initial probability values (which may not be equiprobable) for each context. Specifically, in the AVC and HEVC, given the initial QP of one slice SliceQPY, the initial probability state of one context InitProbState is calculated as follows:

$$m = SlopeId \cdot 5 - 45 \\ n = ( OffsetIdx << 3 ) - 16 \\ InitProbState = Clip 3 ( 1 , 127 , ( m \cdot {SliceQP}_{Y} ) >> 4 + n ) \qquad ( 2 )$$

where SlopeIdx and OffsetIdx (both in the range from 0 to 15) are two initialization parameters, which are predefined and stored as look-up table (LUT), to calculate the initial probability of one context. As shown in equation (2), the initial probability state is modeled by a linear function of the slice QP with the slope equal to (m>>4) and the offset equal to n.

### The Probability Estimation Technique for the CABAC in the VVC

The probability estimation module that is applied in the VVC is kept almost the same as that in the AVC and HEVC, except for the following key differences: First, VVC maintains two probability estimates for each context, where each has its own probability adaptation rate α in equation (1). The final probability that is actually used for arithmetic coding is the average of the two estimates; second, in the VVC, multiple probability LUTs are predefined and used to initialize the probabilities of different contexts of one slice. Meanwhile, similar to the AVC and the HEVC, the initial estimate of the probability is built upon one linear model taking the slice QP as the input. However, in the VVC, the derived value represents the actual probability value; whereas in the AVC/HEVC, it represents the index of the probability state.

### Multi-Hypothesis Probability Estimation

It is obvious that using one fixed adaptation parameter for all the syntax elements may not be optimal due to their different statistical characteristics. On the other hand, it has been proven in several scientific research that better estimation accuracy can be achieved by using multiple probability estimators compared to one single estimator. Therefore, one multi-hypothesis probability estimation scheme is applied in the CABAC design of the VVC, where two different adaptation parameter α0 and α1 are utilized, which correspond to one slow and fast speed for the probability adaptation. By such way, two different probabilities can be calculated for each bin using two adaptation parameters, which are then averaged to generate the final probability of the bin, i.e.,

$${p}_{0} ( t + 1 ) = {p}_{0} ( t ) \cdot ( 1 - {α}_{0} ) + x ( t ) \cdot {α}_{0} {p}_{1} ( t + 1 ) = {p}_{1} ( t ) \cdot ( 1 - {α}_{1} ) + x ( t ) \cdot {α}_{1} p ( t + 1 ) = ( {p}_{0} ( t + 1 ) + {p}_{1} ( t + 1 ) ) / 2 \qquad ( 3 )$$

where α₀ and α₁ are the two adaptation parameters associated with the two probability hypotheses. In the VVC, the values of α₀ and α₁ are independently selected for each context using one training algorithm that is designed to jointly optimize the adaptation parameters as well as the initial probabilities. Specifically, according to the current design, each context is allowed to select α₀ from one set of predefined values of {¼, ⅛, 1/16, 1/32} and α₁ from another set of predefined values of { 1/32, 1/64, 1/128, 1/256, 1/512}.

### Initial Probability Calculation

As in the AVC/HEVC, the CABAC process of the VVC also invoke one QP dependent probability initialization process at the beginning of each slice. However, compared to the AVC/HEVC which initializes the state of one probability state machine, the actual value of the initial probability is directly derived, as depicted as

$$m = ( SlopeIdx >> 3 ) - 4 \\ n = ( ( OffsetIdx \& 7 ) \cdot 18 ) + 1 \\ InitState = Clip 3 ( 1 , 127 , ( m \cdot ( {SliceQP}_{Y} - 16 ) ) >> 1 + n ) \\ {p}_{0}^{i n i t} = initState << 7 \\ {p}_{1}^{i n i t} = initState << 3 \qquad ( 4 )$$

where SlopeIdx and OffsetIdxare two initialization parameters for calculating the slope and offset of the linear model, each being represented in the precision of 3 bit; p₀^{init} and p₁^{init} are the two initial probabilities calculated for two probability estimators.

Compared to the CABAC design in the AVC/HEVC, the probability estimation scheme in the VVC can more precisely capture the true statistical distribution of the bins for each context, leading to the improved CABAC efficiency. However, its design can still be further improved. Specifically, the following deficiencies that exist in the current probability estimation of the VVC CABAC process are identified in this disclosure:

First, as discussed above, in the VVC, multi-hypothesis-based probability estimation scheme is applied, where two probability estimators (one with fast adaption rate and the other with slow adaptation rate), to estimate the probability of the bins for each context model. Additionally, in the existing design, the probability of one bin is just a simple average of the two probability estimators. Such design is suboptimal given that the fixed weight may not be flexible enough to adapt to the varying data statistics of different contexts.

On the other hand, according to the existing VVC design, the probabilities of all the contexts in one slice are initialized based on three sets of initial context values, which are predetermined for different slice types (i.e., I, B and P slices). Among those, the set of the initial context values of I slice type is only allowed to be used for I slices while the set of the initial context values of B and P slices are allowed to be used for either B or P slices. Due to its specific features, the bins of each video bitstream usually presents very different statistical characteristics from each other. Therefore, using only three fixed sets of initial context values are far from optimal to offer efficient starting points for the probability estimator to fast capture the true probability distortion of each context. On the other hand, due to the strong temporal correlation within one video sequence, the probability statistics of the contexts from the slices that are coded before the current slice can potentially provide more accurate estimates to initialize the probabilities of the contexts in the current slice.

In the present disclosure, methods are proposed to resolve the problems/deficiencies that exist in the existing probability estimation scheme in the VVC. Specifically, the following methods are proposed to further improve the probability estimation accuracy while considering the friendliness to hardware codec implementations.

First, to enhance the precision of probability estimation, one binary arithmetic coding with weighted multi-hypothesis probability update is proposed. Specifically, instead of using simple average, the final probability used for coding one bin of each context is calculated as one weighted combination of two probability estimators p₀ and p₁ that are associated with the context. Additionally, multiple initialization methods are proposed to indicate the initial weight parameters for the contexts at the beginning of one slice.

Second, one improved initialization scheme is proposed to initialize the state parameters of the contexts for the slices that are inter coded. Specifically, in addition to using the existing fixed context initialization tables, the proposed scheme allows to initialize the state parameters of the contexts (e.g., the two probability estimators, the adaptation rates and the weighting factors for the combination of two probability estimators in one inter-coded slice) to be copied from the corresponding state parameters of the slices that are previously coded.

### Multi-Hypothesis Probability Estimation with Adaptive Weights

In the VVC, multi-hypothesis-based probability estimation is applied where the final probability when coding each bin of one context is calculated as the average of two probability estimators. Given the specific statistic characteristics of different video bitstreams, it is obvious that such scheme (i.e., using the equal weight (i.e., 0.5)) may not be always flexible enough to capture the true symbol statistics when combining the two probability estimators of one context. Therefore, in this section, one multi-hypothesis probability estimation with adaptive weights (MHP-AW) to further improve the probability estimation accuracy of the VVC is provided. Specifically, same to the VVC CABAC design, two separate probability estimators p₀ and p₁ are maintained for each context and updated based on their own adaption rates α₀ and α₁. However, instead of using fixed average, multiple weight parameters are introduced in the proposed scheme where the final probability p that is used for the binary arithmetic coding of one context is derived based on the weighted combination of the two probability estimators. In details, the proposed probability estimation can be formulated as

$${p}_{0} ( t + 1 ) = {p}_{0} ( t ) \cdot ( 1 - {α}_{0} ) + x ( t ) \cdot {α}_{0} {p}_{1} ( t + 1 ) = {p}_{1} ( t ) \cdot ( 1 - {α}_{1} ) + x ( t ) \cdot {α}_{1} p ( t + 1 ) = ( 1 - ω ) \cdot {p}_{0} ( t ) + ω \cdot {p}_{1} ( t ) \qquad ( 5 )$$

where ω is the weight that is used for the combination of two probability estimations, whose value is obtained from the range [0, 1]. In equation (5), the weight ω represent one real value, which needs to be quantized into integers for hardware/software codec implementations. In practice, different methods may be applied to convert the value of ω into integers. For instance, one uniform quantizer with quantization step qₛₜₑₚ may be applied to approximate the real weight value by the multiplication of one integer and the quantization step, as described as

$$ω = {ω}^{int} \cdot {q}_{step} \qquad ( 6 )$$

where ω^{int} is the integer weight value. Further, the quantization step which is also one real value can be approximated as one right shift operation of M-bit as

$$ω = {ω}^{int} \cdot {q}_{step} = {ω}^{int} >> M \qquad ( 7 )$$

As shown in equation (7), additional memory is required to store the set of the integer weight values ω^{int}'s, when implementing the proposed MHP-AW scheme in hardware/software. Meanwhile, as illustrated in equation (5), the precision of the integer weights (i.e., M) also determines the bit-width of the multiplier that is need for the weighted combination of the two probability estimators. Therefore, in practice, different set of integer weight values and representation precisions may be applied to achieve various trade-off between coding efficiency and hardware/software implementation complexity. For instance, assuming the representation precision M equal to 5, different set of integer values may be applied. In one example, it is proposed to select the optimal weight of each context from one predefined set {0, 3, 6, 10, 13, 16, 19, 22, 26, 29, 32}. In another example, it is proposed to set the weight from one predefined set {0, 6, 11, 16, 21, 26, 32}. In yet another example, it is proposed to use the predefined set of integer weight values {0, 8, 12, 16, 20, 24, 32}. In yet another embodiment, it is provided to use one predefined set of integer weights that contains three different weight values {12, 16, 20} in 5-bit precision.

In all the examples above, the sum of the weights that are applied to the two probabilities p₀(t) and p₁(t) are constrained to be equal to one. Though it can reduce the storage size of keeping the weights (because only one weight value needs to be stored and the other weight can be easily derived from the stored one), such constraint may not be able to maximize the coding gain that the MHP-AW can achieve. Therefore, to further improve the performance, it is provided to apply the weight values (which are not subjected to the constraint that the sum of two weights is equal to one) in the proposed MHP-AW method when combining the two probabilities estimators for each context, i.e.,

$${p}_{0} ( t + 1 ) = {p}_{0} ( t ) \cdot ( 1 - {α}_{0} ) + x ( t ) \cdot {α}_{0} {p}_{1} ( t + 1 ) = {p}_{1} ( t ) \cdot ( 1 - {α}_{1} ) + x ( t ) \cdot {α}_{1} p ( t + 1 ) = {ω}_{0} \cdot {p}_{0} ( t ) + {ω}_{1} \cdot {p}_{1} ( t ) \qquad ( 8 )$$

where ω₀ and ω₁ are the weights being used for the combination of two probability estimations, whose value is obtained from the range [0, 1]. In one example, the values of ω₀ and ω₁ are selected independently such that the sum of ω₀ and ω₁ can be equal to one, less than one, or greater than one. In another example, one constraint may be applied when determining the two weights for the MHP-AW such that the sum of ω₀ and ω₁ is either equal to one or less than one, i.e., ω₀+ω₁≤1. In yet another example, it still allows the arbitrary selection of the two weights ω₀ and ω₁; but in order to keep the range of the final probability p within the original range [0, 1], it is provided to apply additional 1-bit right-shift (i.e., equivalently division by 2) to derive the final probability when the sum of ω₀ and ω₁ is greater than one; otherwise (the sum of ω₀ and ω₁ is less than or equal to one), the final probability is calculated as the direct weighed combination of two probability estimators, i.e.,

$${p}_{0} ( t + 1 ) = {p}_{0} ( t ) \cdot ( 1 - {α}_{0} ) + x ( t ) \cdot {α}_{0} {p}_{1} ( t + 1 ) = {p}_{1} ( t ) \cdot ( 1 - {α}_{1} ) + x ( t ) \cdot {α}_{1} {p}_{t} ( t + 1 ) = \{ \begin{matrix}{ω}_{0} \cdot {p}_{0} ( t ) + {ω}_{1} \cdot {p}_{1} ( t ) , & {ω}_{0} + {ω}_{1} \leq 1 \\ \frac{( {ω}_{0} \cdot {p}_{0} ( t ) + {ω}_{1} \cdot {p}_{1} ( t ) )}{2} , & {ω}_{0} + {ω}_{1} > 1\end{matrix} \qquad ( 9 )$$

In the example above, when the sum of two probabilities is greater than one, the combined probability is divided by 2 to calculate the final probability of the arithmetic coding. In other methods, other constant values (e.g., M) may be applied in the proposed scheme to achieve different weighted combination of two probability estimators; specifically, by such way, the equation (9) may be generalized as

$${p}_{0} ( t + 1 ) = {p}_{0} ( t ) \cdot ( 1 - {α}_{0} ) + x ( t ) \cdot {α}_{0} {p}_{1} ( t + 1 ) = {p}_{1} ( t ) \cdot ( 1 - {α}_{1} ) + x ( t ) \cdot {α}_{1} {p}_{t} ( t + 1 ) = \{ \begin{matrix}{ω}_{0} \cdot {p}_{0} ( t ) + {ω}_{1} \cdot {p}_{1} ( t ) , & {ω}_{0} + {ω}_{1} \leq 1 \\ \frac{( {ω}_{0} \cdot {p}_{0} ( t ) + {ω}_{1} \cdot {p}_{1} ( t ) )}{M} , & {ω}_{0} + {ω}_{1} > 1\end{matrix} \qquad ( 10 )$$

Similarly, when the example above is applied, the weight values need to be approximated to integer values and different set of integer weights (in various representation precisions) can be applied in practice for different performance/complexity tradeoffs. As specific examples, assuming the precision of storing the weights is 5-bit, the weights can be selected from one predefined set {0, 3, 6, 10, 13, 16, 19, 22, 26, 29, 32}. In another example, the weights are selected from one predefined set {0, 6, 11, 16, 21, 26, 32}. In yet another example, it is provided to use the predefined set of integer weight values {0, 8, 12, 16, 20, 24, 32}. In the final example, it is provided to use one predefined set of integer weights that contains three different weight values {12, 16, 20}.

Similar to the probability and adaption rate, in the proposed MHP-AW scheme, one initial value of the weight ω^{int} needs to be provided for each context at the beginning of one slice. In the following, different schemes are proposed for the initialization of the MHP-AW weights. In the first method, it is proposed to define a plurality of different predefined tables, each contains a set of weight initialization values for all the contexts in one slice. Before encoding/decoding one slice, one predefined table may be selected and the corresponding MHP-AW weights are initialized based on the corresponding weight values of the table. For instance, in one embodiment, a number of slice-type-dependent initial weight tables may be derived, e.g., three sets of weight initialization tables designed specifically for I, P and B slices. By such way, for one slice, video encoder may select one from the three predefined tables to initialize the MHP-AW weights to better adapt to the symbol statistics in the slice. When such scheme is applied, one additional syntax element sh_cabac_weight_init_idx may be signaled for each slice, indicating which initial weight table is selected for the slice, as illustrated as in Table 1 below:

TABLE 1

| | Descriptor |
|---|---|
| slice_header( ) { | |
| ...... | |
| if( pps_cabac_weight_init_present_flag ) | |
| sh_cabac_weight_init_idx | ue(v) |
| ...... | |
| } | |

where the syntax pps_cabac_weight_init_present_flag is one control flag that is signaled in picture parameter set (PPS) indicating whether it is allowed to select different initial weight tables for each slice. When the flag is enabled, another syntax sh_cabac_weight_init_idx is further signaled at slice level to indicate the selected initial weight table. In another embodiment, it is proposed to only allow the MHP-AW weights of I slice to be initialized by the initial weight table associated with the I slice type while the MHP-AW weights of P and B slices are allowed to be initialized from one of the predefined weight initialization tables. Specifically, in addition to the initial weight table associated with the slice type of the current slice, it is proposed to only allow one P (or B) slice to be initialized with the initial weight table of B (or P) slice type. Correspondingly, in such case, only one flag needs to be signaled for each slice for the initial table selection of the MHP-AW weights for P/B slices, as depicted in Table 2 below:

TABLE 2

| | Descriptor |
|---|---|
| slice_header( ) { | |
| ...... | |
| if( sh_slice_type != I ) { | |
| if( pps_cabac_weight_init_present_flag ) | |
| sh_cabac_weight_init_flag | ue(v) |
| } | |
| ...... | |
| } | |

When the flag sh_cabac_weight_init_flag is equal to 0, it means that the initial weight table corresponding to the slice type of the current slice is used to initialize the values of the MHP-AW weights of the slice; When the flag is equal to 1, it means that the initial weight table corresponding to P slice type is used to initialize the values of the MHP-AW weights in the slice when the current slice is one B slice and the initial weight table corresponding to B slice type is used to initialize the values of the MHP-AW weights in the slice when the current slice is one P slice.

Further, in another embodiment of the present disclosure, it is provided to extend the existing CABAC initialization tables to include the corresponding MHP-AW weight for each context. Specifically, after such change, each element of one CABAC initialization table contains three different categories of information, including 1) the initial probability values, 2) the adaption rates used to initialize the probabilities and adaptation speeds of two probability hypotheses, and 3) the MHP-AW weight used to combine the two hypotheses when updating the probability of each context. Similar to the existing VVC design, when such scheme is applied, a plurality of CABAC initialization tables may be pre-determined and the syntax elements may be signaled from encoder to decoder to inform which initialization table will be selected for each slice to initialize the corresponding values of the two probabilities, the two adaption rates as well as the combination weight associated with each slice. In one specific embodiment, it is proposed to reuse the existing CABAC initialization syntax elements, i.e., pps_cabac_init_present_flag and sh_cabac_init_flag, to indicate the selection of the CABAC initialization table at slice. When such method is applied, the CABAC states (i.e., probabilities, adaptation rates and combination weight) of I slice are only allowed to be initialized by the initialization table of the I slice type while the CABAC states of P (or B) slice are allowed to be initialized with the initialization tables of the B (or P) slice type. In another embodiment, it is proposed to predetermine a number of the CABAC tables (>3) and the CABAC states of one slice are allowed to be arbitrarily initialized from one of the predefined tables.

In all the above methods, fixed values are used to initialize the MHP-AW weights of the contexts when coding one slice, which may not be accurate to provide reliable probability estimation for arithmetic coding. To resolve such issue, it is provided to give encoder the flexibility to calculate the optimal MHP-AW weights for each slice and signal the corresponding optimal MHP-AW weights to decoder.

In one embodiment, it is provided to directly signal the weight value of each context element. For instance, one flag may be firstly signaled to indicate whether the MHP-AW weights of the contexts in the slice are initialized with one fixed initialization table. When the flag is equal to one, another syntax element may be signaled to inform the decoder which weight initialization table is applied to the current slice; otherwise, i.e., the flag is equal to 0, the MHP-AW weights of the contexts in the slice will be initialized by the values that are parsed from the bitstream. In practice, different binarization methods may be applied to generate the codewords of the MHP-AW weight values, e.g., fixed-length code, unary code, k-th order Exponential-Golomb code and so forth.

In another embodiment, one adaptive signaling method is proposed. Specifically, at the beginning of each slice, the scheme firstly transmits a binary map weightMap[ ] from encoder to decoder, where each element indicates whether the corresponding context uses the initialized weight values from the selected default initialization weight table. When the i-th weightMap[ ] map entry is equal to 0, it means that the MHP-AW weight of the i-th context of the current slice will be initialized by the corresponding values in the selected initialization weight table. When the i-th weightMap[ ] map entry is equal to 1, it means that the MHP-AW weight of the i-th context of the current slice will be initialized by the initial value that is indicated in the bitstream. Different methods may be applied to code the map weightMap[ ]. In one example, it is proposed to use run-length coding to code the binary values of the map where one “run” values are sent to indicate the number of consecutive 0s (or 1s) before one 1 (or 0) is met.

### Initial CABAC State Inheritance from Previously Coded Slices

As discussed above, the symbols of the same context in different video bitstreams usually present quite different statistical characteristics. Given that the probability states are fixed in the predefined CABAC table and are not able to adapt to the specific features of different slices. There is potential coding efficiency drop when the predefined initial table deviates from the true symbol statistics of the video bitstream. To improve the CABAC efficiency, improved CABAC initialization schemes are proposed for the initialization of the contexts from the context states after encoding/decoding one previous slice. There may be different ways to identify the previous slice for the CABAC initialization.

In one embodiment, it is provided to maintain the output context states of N previously coded slices. When one current slice is encoded, a video encoder will select the best one from the N previously coded slices and signal one index to decoder to initialize the contexts of the current slice from the corresponding context states of the selected previously coded slice (as indicated by the signaled index value).

In other embodiments, instead of directly signaling the selected previously coded slice in bitstreams, some implicit decoder-side selection schemes may be applied to select the corresponding previously coded slice for the context initialization of the current slice, including:
Rule #1: It is proposed to directly select the slice that is coded just before the slice according to the coding order.
Rule #2: It is proposed to select the previously coded slice that is closest to the current slice according to the order and has the same slice type.
Rule #3: It is proposed to select the previously coded slice that is closest to the current slice according to the order and has the smallest QP difference to the current slice.
Rule #4: It is proposed to select the previously coded slice that is closest to the current slice according to the order and has the same temporal layer as the current slice.

Although the above implicit selection rules are proposed separately, it may also be combined and applied together in the provided initial CABAC state inheritance scheme. In one specific example, it is proposed to combine Rule #2, #3 and #4 together. Specifically, based on such combination, encoder/decoder may select the previously codes slice in the same slice type, which is closest to the current slice according to the coding order, has the smallest QP difference to the current slice and has the same temporal layer as the current slice. In case such previously coded slice does not exist, one of the existing predefined CABAC initialization tables may be applied to initial the context states of the current slice. Additionally, when any of the above methods is applied, one additional inheritance constraint may be applied to prevent one slice to inherit its context states from another slice that is located at the same picture that the slice belongs to.

Additionally, in the provided inheritance-based context initialization scheme, the inherited context states may include different categories of state information, e.g., the probability values, the adaption rates and the combination weights (when the provided MHP-AW scheme is applied). In one embodiment of the disclosure, it is proposed to only inherit one state information from the selected previously coded slice while the other state information of the current slice is initialized using the existing predefined CABAC initialization tables. In another embodiment, it is proposed to only inherit two state information from the selected previously coded slice. In yet another embodiment, it is proposed to inherit all the state information of the current slice from the corresponding context states of the selected previously coded slice.

Though it can improve the efficiency of context initialization, the above inheritance-based CABAC initialization may introduce parsing dependency between different slices. This is because the entropy coding of one current slice cannot be invoked until the entropy coding of its reference slice (i.e., the selected previously coded slice) is fully finished.

To provide a better control of the efficiency and the parallelism of entropy coding, one adaptive CABAC initialization scheme is proposed in which the context states of one current slice may be initialized by one of two ways: 1) to be initialized by using one of the predefined CABAC initialization tables; or 2) to be initialized by the resulting context states of one previously coded slice. Specifically, in the proposed scheme, one binary flag is firstly signaled at the beginning of one slice. When the flag is equal to zero, it means the contexts of the current slice will be initialized by one of the existing predefined CABAC initialization tables, e.g., as indicated by the syntax element sh_cabac_init_flag. When the flag is equal to one, it means that the inheritance-based context initialization method will be applied, where the initialize context values will be set to be the context states output from the selected slice that is coded ahead the current slice.

In another example, it is provided to store the context states (e.g., the probabilities, the adaptation rates and the MHP-AW weights) after the coding of one fixed block in the previously coded picture is finished and the stored context states will be used as the candidate to initialize the context states of the slices that are coded in future. Additionally, in order to achieve different tradeoff between coding efficiency and parsing dependency, it is provided to signal the position of the storage position (i.e., the position of storing the context states in one picture) in bitstream. Using CTU as the basic unit of storing the context states in the provided examples, the Table 3 below shows one example where one additional syntax element (pps_pos_store_context_state_in_ctu) is introduced in the PPS to indicate the location of storing the context states in each picture.

TABLE 3

| | Descriptor |
|---|---|
| picture_parameter_set ( ) { | |
| ...... | |
| if( pps_cabac_weight_init_present_flag ) | |
| pps_pos_store_context_state_in_ctu | ue(v) |
| ...... | |
| } | |

where the syntax pps_cabac_weight_init_present_flag is the control flag that is signaled in picture parameter set (PPS) indicating whether it is allowed to context state inheritance for inter slices that refer to the PPS. When the flag is enabled, another syntax pps_pos_store_context_state_in_ctu is further signaled to indicate the location of the CTU where to store the corresponding context states after it is coded.

In another example, it is provided to indicate the location of storing context states at other granularities. In one specific example, it is provided to store the context states in one picture based on the granularity of CTU rows. Correspondingly, when such scheme is applied, one additional syntax element pps_pos_store_context_state_in_ctu_row may be signaled to identify the CTU row where the resulting context states are to be stored after all the CTUs in the row are fully coded. Additionally, though in the above example the context state storage location is signaled in the PPS, in practice, those syntax elements may be signaled at various levels, e.g., sequence parameter set (SPS), picture header, slice header, CTU level or even coding block group level.

In another specific example, it is provided to select the context storage position from two pre-defined locations in one picture: 1) storing the context states after all the CTUs in one picture are fully coded; 2) storing the context state after one target CTU at the location (PicWidthInCTU·PicHeightInCTU)/2+PicWidthInCTU/2 is coded. Table 4 below shows one example where one corresponding flag is signaled in the PPS to indicate the corresponding storage location of the context states in each picture:

TABLE 4

| | Descriptor |
|---|---|
| picture_parameter_set ( ) { | |
| ...... | |
| if( pps_cabac_weight_init_present_flag ) | |
| pps_store_context_state_sel_flag | ue(v) |
| ...... | |
| } | |

When the flag pps_store_context_state_sel_flag is equal to 0, it means the target CTU used to store the context states is the middle CTU that is located at (PicWidthInCTU·PicHeightInCTU)/2+PicWidthInCTU/2; otherwise, it means the target CTU used to store the context states is the last CTU in one picture.

Additionally, instead of signaling the context state storage position in bitstream, it is provided in another example to use one fixed location (e.g., the last CTU or the middle CTU in one picture) in both encoder and decoder.

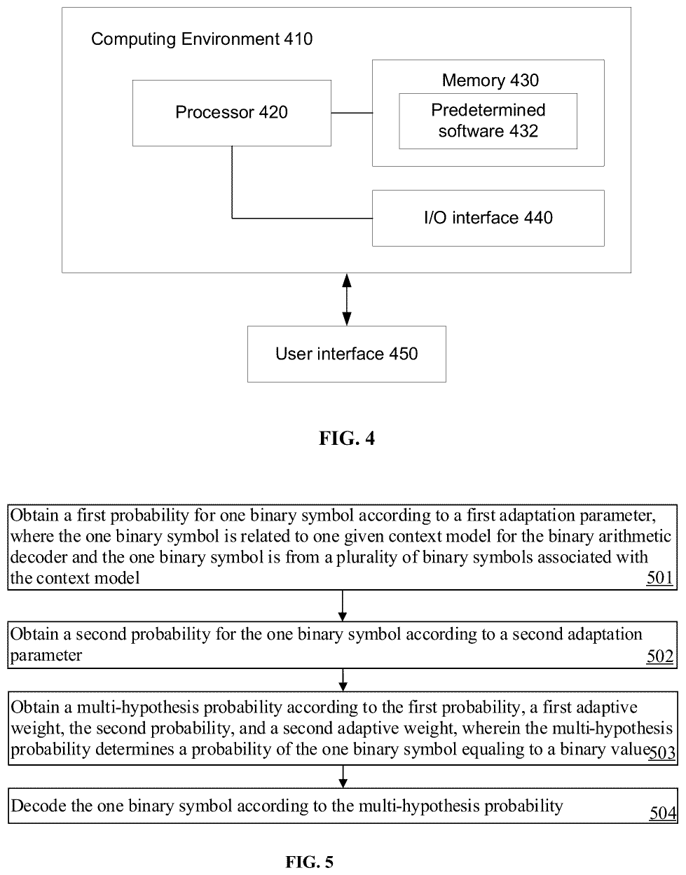

FIG. 4 shows a computing environment (or a computing device) 410 coupled with a user interface 460. The computing environment 410 can be part of a data processing server. In some embodiments, the computing device 410 can perform any of various methods or processes (such as encoding/decoding methods or processes) as described hereinbefore in accordance with various examples of the present disclosure. The computing environment 410 may include a processor 420, a memory 440, and an I/O interface 450.

The processor 420 typically controls overall operations of the computing environment 410, such as the operations associated with the display, data acquisition, data communications, and image processing. The processor 420 may include one or more processors to execute instructions to perform all or some of the steps in the above-described methods. Moreover, the processor 420 may include one or more modules that facilitate the interaction between the processor 420 and other components. The processor may be a Central Processing Unit (CPU), a microprocessor, a single chip machine, a GPU, or the like.

The memory 440 is configured to store various types of data to support the operation of the computing environment 410. Memory 440 may include predetermine software 442. Examples of such data include instructions for any applications or methods operated on the computing environment 410, video datasets, image data, etc. The memory 440 may be implemented by using any type of volatile or non-volatile memory devices, or a combination thereof, such as a static random access memory (SRAM), an electrically crasable programmable read-only memory (EEPROM), an crasable programmable read-only memory (EPROM), a programmable read-only memory (PROM), a read-only memory (ROM), a magnetic memory, a flash memory, a magnetic or optical disk.

The I/O interface 450 provides an interface between the processor 420 and peripheral interface modules, such as a keyboard, a click wheel, buttons, and the like. The buttons may include but are not limited to, a home button, a start scan button, and a stop scan button. The I/O interface 450 can be coupled with an encoder and decoder.

In some embodiments, there is also provided a non-transitory computer-readable storage medium including a plurality of programs, such as included in the memory 440, executable by the processor 420 in the computing environment 410, for performing the above-described methods. For example, the non-transitory computer-readable storage medium may be a ROM, a RAM, a CD-ROM, a magnetic tape, a floppy disc, an optical data storage device or the like.

The non-transitory computer-readable storage medium has stored therein a plurality of programs for execution by a computing device having one or more processors, where the plurality of programs when executed by the one or more processors, cause the computing device to perform the above-described method.

In some embodiments, the computing environment 410 may be implemented with one or more application-specific integrated circuits (ASICs), digital signal processors (DSPs), digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

FIG. 5 is a flowchart illustrating a method for video decoding according to an example of the present disclosure. The method may be implemented by a binary arithmetic decoder.

In step 501, the processor 420, at the side of a binary arithmetic decoder, may obtain a first probability for one binary symbol according to a first adaptation parameter, where the one binary symbol is related to one given context model for the binary arithmetic decoder and the one binary symbol is from a plurality of binary symbols associated with the context model. In some examples, the decoder may obtain a first probability for a binary symbol using a binary arithmetic decoder, based on a given context model and a first adaptation parameter, where the binary symbol is one of a plurality of binary symbols associated with the context model.

In step 502, the processor 420 may obtain a second probability for the one binary symbol according to a second adaptation parameter. In some examples, the first and second adaptive weights may be respectively obtained from a pre-defined range. For example, as shown in equation (8), ω₀ and ω₁ are the weights being used for the combination of two probability estimations, whose value may be obtained from the range [0, 1].

In some examples, the first and second adaptive weights may be independently obtained, and a sum of the first adaptive weight and the second adaptive weight meets one of following conditions: the sum is equal to 1, the sum is less than 1, or the sum is greater than 1.

In some examples, the processor 420 may further obtain a third probability as a weighted combination of the first probability and the second probability according to the first adaptive weight and the second adaptive weight.

In some examples, the processor 420 may further obtain the multi-hypothesis probability according to the third probability and the sum of the first adaptive weight and the second adaptive weight.

In some examples, the processor 420 may obtain the multi-hypothesis probability by applying a right shift operation to the third probability in response to determining that the sum of the first adaptive weight and the second adaptive weight is greater than 1. Furthermore, the processor 420 may obtain the multi-hypothesis probability by dividing the third probability by a constant value in response to determining that the sum of the first adaptive weight and the second adaptive weight is greater than 1.

In some examples, the processor 420 may obtain the multi-hypothesis probability being equal to the third probability in response to determining that the sum of the first adaptive weight and the second adaptive weight is no greater than 1.

For example, as shown in equation (9), when the sum of two probabilities is greater than one, the third probability may be the combined probability that is divided by 2 to calculate the final probability of the arithmetic coding. As shown in equation (10), the third probability may also be the combined probability that is divided by other constant values, e.g., M, to calculate the final probability of the arithmetic coding.

For example, as shown in equation (9) or (10), in order to keep the range of the final probability p within the original range [0, 1], additional 1-bit right-shift (i.e., equivalently division by 2) may be applied to derive the final probability when the sum of ω₀ and ω₁ is greater than one; otherwise (the sum of ω₀ and ω₁ is less than or equal to one), the final probability is calculated as the direct weighed combination of two probability estimators as shown in equation (9). In some examples, other constant values (e.g., M) may be applied to achieve different weighted combination of two probability estimators, as shown in equation (9).

In some examples, the processor 420 may obtain the first adaptive weight from a set of predetermined weight values.

In some examples, the processor 420 may obtain the set of predetermined weight values from a set of predetermined integer values divided by one constant value.

For example, assuming the precision of storing the weights is 5-bit, the weights may be selected from one predefined set {0, 3, 6, 10, 13, 16, 19, 22, 26, 29, 32}. In another example, the weights may be selected from one predefined set {0, 6, 11, 16, 21, 26, 32}. In yet another example, the predefined set of integer weight values {0, 8, 12, 16, 20, 24, 32} may be used. In yet another example, one predefined set of integer weights that contains three different weight values {12, 16, 20} may be used.

In step 503, the processor 420 may obtain a multi-hypothesis probability according to the first probability, a first adaptive weight, the second probability, and a second adaptive weight, where the multi-hypothesis probability determines a probability of the one binary symbol equaling to a binary value.

For example, the multi-hypothesis probability may be pₜ(t+1) as shown in equation (9) or (10).

In step 504, the processor 420 may decode the one binary symbol according to the multi-hypothesis probability.

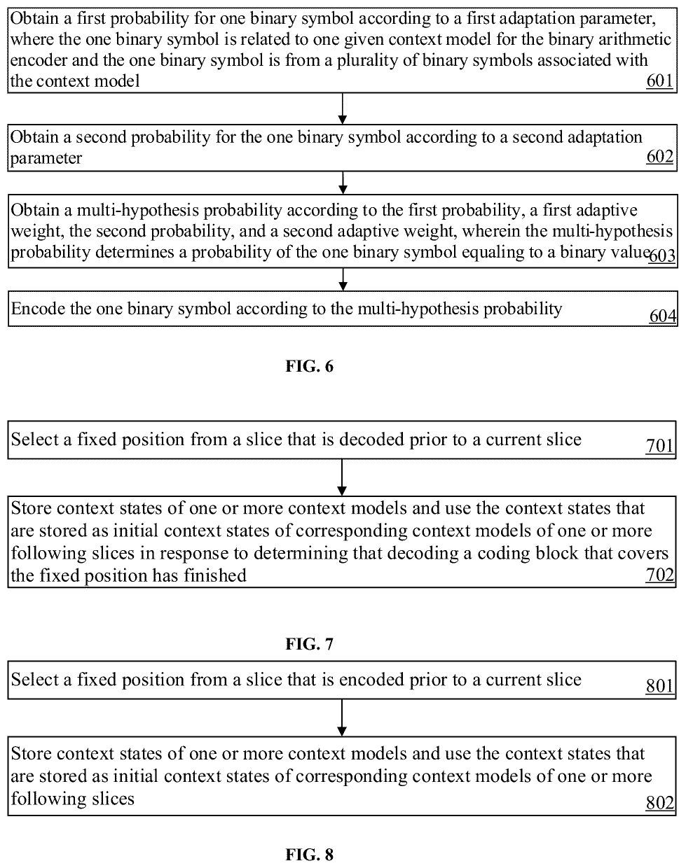

FIG. 6 is a flowchart illustrating a method for video encoding corresponding the method for video decoding as shown in FIG. 5. The method may be implemented by a binary arithmetic encoder.

In step 601, the processor 420, at the side of one binary arithmetic encoder, may obtain a first probability for one binary symbol according to a first adaptation parameter, where the one binary symbol is related to one given context model for the binary arithmetic encoder and the one binary symbol is from a plurality of binary symbols associated with the context model.

In step 602, the processor 420 may obtain a second probability for the one binary symbol according to a second adaptation parameter. In some examples, the first and second adaptive weights may be respectively obtained from a pre-defined range. For example, as shown in equation (8), ω₀ and ω₁ are the weights being used for the combination of two probability estimations, whose value may be obtained from the range [0, 1].

In some examples, the first and second adaptive weights may be independently obtained, and a sum of the first adaptive weight and the second adaptive weight meets one of following conditions: the sum is equal to 1, the sum is less than 1, or the sum is greater than 1.

In some examples, the processor 420 may further obtain a third probability as a weighted combination of the first probability and the second probability according to the first adaptive weight and the second adaptive weight.

In some examples, the processor 420 may further obtain the multi-hypothesis probability according to the third probability and the sum of the first adaptive weight and the second adaptive weight.

In some examples, the processor 420 may obtain the multi-hypothesis probability by applying a right shift operation to the third probability in response to determining that the sum of the first adaptive weight and the second adaptive weight is greater than 1. Furthermore, the processor 420 may obtain the multi-hypothesis probability by dividing the third probability by a constant value in response to determining that the sum of the first adaptive weight and the second adaptive weight is greater than 1.

In some examples, the processor 420 may obtain the multi-hypothesis probability being equal to the third probability in response to determining that the sum of the first adaptive weight and the second adaptive weight is no greater than 1.

For example, as shown in equation (9), when the sum of two probabilities is greater than one, the third probability may be the combined probability that is divided by 2 to calculate the final probability of the arithmetic coding. As shown in equation (10), the third probability may also be the combined probability that is divided by other constant values, e.g., M, to calculate the final probability of the arithmetic coding.

For example, as shown in equation (9) or (10), in order to keep the range of the final probability p within the original range [0, 1], additional 1-bit right-shift (i.e., equivalently division by 2) may be applied to derive the final probability when the sum of ω₀ and ω₁ is greater than one; otherwise (the sum of ω₀ and ω₁ is less than or equal to one), the final probability is calculated as the direct weighed combination of two probability estimators as shown in equation (9). In some examples, other constant values (e.g., M) may be applied to achieve different weighted combination of two probability estimators, as shown in equation (9).

In some examples, the processor 420 may obtain the first adaptive weight from a set of predetermined weight values.

In some examples, the processor 420 may obtain the set of predetermined weight values from a set of predetermined integer values divided by one constant value.

For example, assuming the precision of storing the weights is 5-bit, the weights may be selected from one predefined set {0, 3, 6, 10, 13, 16, 19, 22, 26, 29, 32}. In another example, the weights may be selected from one predefined set {0, 6, 11, 16, 21, 26, 32}. In yet another example, the predefined set of integer weight values {0, 8, 12, 16, 20, 24, 32} may be used. In yet another example, one predefined set of integer weights that contains three different weight values {12, 16, 20} may be used.

In step 603, the processor 420 may obtain a multi-hypothesis probability according to the first probability, a first adaptive weight, the second probability, and a second adaptive weight, where the multi-hypothesis probability determines a probability of the one binary symbol equaling to a binary value.

For example, the multi-hypothesis probability may be pₜ(t+1) as shown in equation (9) or (10).

In step 604, the processor 420 may encode the one binary symbol according to the multi-hypothesis probability.

FIG. 7 is a flowchart illustrating a method for video decoding according to an example of the present disclosure.

In step 701, the processor 420, at the side of a decoder, may select a fixed position from a slice that is decoded prior to a current slice.

In some examples, the processor 420 may receive a context state storage position from a bitstream sent by an encoder, where the context state storage position indicates the fixed position in the slice.

In some examples, the context state storage position may be signaling in the bitstream at a certain level by the encoder and sent to the decoder, where the certain level comprises a picture parameter set (PPS) level, a sequence parameter set (SPS) level, a picture level, a slice level, a coding tree unit (CTU) level, or a coding block group level.

In some examples, the context state storage position may be pre-defined at one of following positions: one position in a CTU in the slice or the last position of one CTU row.

In some examples, the processor 420 may obtain a control syntax element that indicates whether context state inheritance for inter slices is allowed. Furthermore, the processor 420 may obtain a context state storage position syntax element that indicates a context state storage position indicating the fixed position in the slice in response to determining that the control syntax element is enabled. For example, the control syntax element may be syntax clement pps_cabac_weight_init_present_flag in Table 3 and the context state storage position syntax element may be syntax clement pps_pos_store_context_state_in_ctu in Table 3.

In some examples, the processor 420 may pre-define that the fixed position is located in the last position of the last CTU in the slice or the middle position of the middle CTU in the slice. Assuming the CTU size is M×M and (x, y) represents one coordinate in the CTU where both x and y are ranging from 0 to M−1. The last position of the CTU is the position at the coordinate (M−1, M−1) and the middle position of the CTU is the position at the coordinate (M/2, M/2). M may be a positive integer.

In some examples, the processor 420 may obtain a store context state syntax element that indicates where the fixed position is located. Furthermore, the processor 420 may obtain the fixed position from the middle position of the middle CTU in the slice in response to determining that the store context state syntax element is equal to 0 and may obtain the fixed position from the last position of the last CTU in the slice in response to determining that the store context state syntax element is equal to 1. For example, the store context state syntax clement may be syntax element pps_store_context_state_sel_flag in Table 4.

In some examples, the slice and the current slice may be not located in the same picture. For example, when any of the Rules in the section of “Initial CABAC state inheritance from previously coded slices” is applied, one additional inheritance constraint rule may be applied to prevent one slice to inherit its context states from another slice that is located at the same picture that the slice belongs to.

In step 702, the processor 420 may store context states of one or more context models and use the context states that are stored as initial context states of context models of one or more following slices in response to determining that decoding a coding block that covers the fixed position has finished. The one or more following slices may be the slices that are to be coded after the slice in step 701. The context models of the one or more following slices may correspond to the stored context states of one or more context models.

In some examples, the context states may include one or more context information including initial probability values, adaptation rates and adaptive probability weights.

FIG. 8 is a flowchart illustrating a method for video encoding corresponding the method for video decoding as shown in FIG. 7.

In step 801, the processor 420, at the side of an encoder, may select a fixed position from a slice that is encoded prior to a current slice.

In some examples, the processor 420 may signal a context state storage position, where the context state storage position indicates the fixed position in the slice.

In some examples, the context state storage position is signaling in the bitstream at a certain level, where the certain level may include a PPS level, an SPS level, a picture level, a slice level, a CTU level, or a coding block group level.

In some examples, the context state storage position may be pre-defined at one of following positions: one position in a coding tree unit (CTU) in the slice or the last position of one CTU row.

In some examples, the processor 420 may signal a control syntax element that indicates whether context state inheritance for inter slices is allowed. Furthermore, the processor 420 may signal a context state storage position syntax element that indicates a context state storage position indicating the fixed position in the slice in response to determining that the control syntax element is enabled. For example, the control syntax element may be syntax element pps_cabac_weight_init_present_flag in Table 3 and the context state storage position syntax element may be syntax element pps_pos_store_context_state_in_ctu in Table 3.

In some examples, the processor 420 may pre-define that the fixed position is located in the last position of the last CTU in the slice or the middle position of the middle CTU in the slice.

In some examples, the processor 420 may signal a store context state syntax clement that indicates where the fixed position is located. Furthermore, the processor 420 may obtain the fixed position from the middle position of the middle CTU in the slice in response to determining that the store context state syntax element is equal to 0 and may obtain the fixed position from the last position of the last CTU in the slice in response to determining that the store context state syntax clement is equal to 1. For example, the store context state syntax clement may be syntax element pps_store_context_state_sel_flag in Table 4.

In some examples, the slice and the current slice may be not located in the same picture. For example, when any of the Rules in the section of “Initial CABAC state inheritance from previously coded slices” is applied, one additional inheritance constraint rule may be applied to prevent one slice to inherit its context states from another slice that is located at the same picture that the slice belongs to.

In step 802, the processor 420 may store context states of one or more context models and use the context states that are stored as initial context states of context models of one or more following slices. The one or more following slices may be the slices that are to be coded after the slice in step 801. The context models of the one or more following slices may correspond to the stored context states of one or more context models.

In some examples, the context states may include one or more context information including initial probability values, adaptation rates and adaptive probability weights.

In some examples, there is provided an apparatus for video coding. The apparatus includes a processor 420 and a memory 440 configured to store instructions executable by the processor; where the processor, upon execution of the instructions, is configured to perform any method as illustrated in FIGS. 5-8.

In some other examples, there is provided a non-transitory computer readable storage medium, having instructions stored therein. When the instructions are executed by a processor 420, the instructions cause the processor to perform any method as illustrated in FIGS. 1-8. In one example, the plurality of programs may be executed by the processor 420 in the computing environment 410 to receive (for example, from the video encoder 20 in FIG. 1G) a bitstream or data stream including encoded video information (for example, video blocks representing encoded video frames, and/or associated one or more syntax elements, etc.), and may also be executed by the processor 420 in the computing environment 410 to perform the decoding method described above according to the received bitstream or data stream. In another example, the plurality of programs may be executed by the processor 420 in the computing environment 410 to perform the encoding method described above to encode video information (for example, video blocks representing video frames, and/or associated one or more syntax elements, etc.) into a bitstream or data stream, and may also be executed by the processor 420 in the computing environment 410 to transmit the bitstream or data stream (for example, to the video decoder 30 in FIG. 2B). Alternatively, the non-transitory computer-readable storage medium may have stored therein a bitstream or a data stream including encoded video information (for example, video blocks representing encoded video frames, and/or associated one or more syntax elements etc.) generated by an encoder (for example, the video encoder 20 in FIG. 1G) using, for example, the encoding method described above for use by a decoder (for example, the video decoder 30 in FIG. 2B) in decoding video data. The non-transitory computer-readable storage medium may be, for example, a ROM, a Random Access Memory (RAM), a CD-ROM, a magnetic tape, a floppy disc, an optical data storage device or the like.

Other examples of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only.

It will be appreciated that the present disclosure is not limited to the exact examples described above and illustrated in the accompanying drawings, and that various modifications and changes can be made without departing from the scope thereof.

What is claimed is:

1. A method for video decoding, comprising:
obtaining a first probability for one binary symbol according to a first adaptation parameter, wherein the one binary symbol is related to one given context model for the binary arithmetic decoder and the one binary symbol is from a plurality of binary symbols associated with the context model;
obtaining a second probability for the one binary symbol according to a second adaptation parameter;
obtaining a multi-hypothesis probability according to the first probability, a first adaptive weight, the second probability, and a second adaptive weight, wherein the multi-hypothesis probability determines a probability of the one binary symbol equaling to a binary value; and
decoding the one binary symbol according to the multi-hypothesis probability.

2. The method of claim 1, further comprising:
obtaining the first adaptive weight from a pre-defined range; and
obtaining the second adaptive weight from the pre-defined range.

3. The method of claim 1, further comprising:
independently obtaining the first adaptive weight and the second adaptive weight, wherein a sum of the first adaptive weight and the second adaptive weight meets one of following conditions:
the sum is equal to 1;
the sum is less than 1; or
the sum is greater than 1; and
wherein obtaining the multi-hypothesis probability according to the first probability, the first adaptive weight, the second probability, and the second adaptive weight comprises:
obtaining a third probability as a weighted combination of the first probability and the second probability according to the first adaptive weight and the second adaptive weight; and
obtaining the multi-hypothesis probability according to the third probability and the sum of the first adaptive weight and the second adaptive weight.

4. The method of claim 3, wherein obtaining the multi-hypothesis probability according to the third probability and the sum of the first adaptive weight and the second adaptive weight comprises:
in response to determining that the sum of the first adaptive weight and the second adaptive weight is greater than 1, obtaining the multi-hypothesis probability by applying a right shift operation to the third probability.

5. The method of claim 3, wherein obtaining the multi-hypothesis probability according to the third probability and the sum of the first adaptive weight and the second adaptive weight comprises:
in response to determining that the sum of the first adaptive weight and the second adaptive weight is greater than 1, obtaining the multi-hypothesis probability by dividing the third probability by a constant value.

6. The method of claim 3, wherein obtaining the multi-hypothesis probability according to the third probability and the sum of the first adaptive weight and the second adaptive weight comprises:
in response to determining that the sum of the first adaptive weight and the second adaptive weight is no greater than 1, obtaining the multi-hypothesis probability being equal to the third probability.

7. The method of claim 1, further comprising:
obtaining the first adaptive weight from a set of predetermined weight values.

8. The method of claim 7, further comprising:
obtaining the set of predetermined weight values from a set of predetermined integer values divided by one constant value.

9. An apparatus for video decoding, comprising:
one or more processors; and
a memory coupled to the one or more processors and configured to store instructions and a bitstream to be processed,
wherein the one or more processors, upon execution of the instructions, are configured to:
obtain a first probability for one binary symbol from the bitstream according to a first adaptation parameter, wherein the one binary symbol is related to one given context model for a binary arithmetic decoder and the one binary symbol is from a plurality of binary symbols associated with the context model;
obtain a second probability for the one binary symbol according to a second adaptation parameter;
obtain a multi-hypothesis probability according to the first probability, a first adaptive weight, the second probability, and a second adaptive weight, wherein the multi-hypothesis probability determines a probability of the one binary symbol equaling to a binary value; and
decoding the one binary symbol according to the multi-hypothesis probability.

10. The apparatus of claim 9, wherein the one or more processors are further configured to:
obtain the first adaptive weight from a pre-defined range; and
obtain the second adaptive weight from the pre-defined range.

11. The apparatus of claim 9, wherein the one or more processors are further configured to:
independently obtain the first adaptive weight and the second adaptive weight, wherein a sum of the first adaptive weight and the second adaptive weight meets one of following conditions:
the sum is equal to 1;
the sum is less than 1; or
the sum is greater than 1; and
obtain a third probability as a weighted combination of the first probability and the second probability according to the first adaptive weight and the second adaptive weight; and
obtain the multi-hypothesis probability according to the third probability and the sum of the first adaptive weight and the second adaptive weight.

12. The apparatus of claim 11, wherein the one or more processors are further configured to perform one of followings:
in response to determining that the sum of the first adaptive weight and the second adaptive weight is greater than 1, obtain the multi-hypothesis probability by applying a right shift operation to the third probability;
in response to determining that the sum of the first adaptive weight and the second adaptive weight is greater than 1, obtain the multi-hypothesis probability by dividing the third probability by a constant value; or
in response to determining that the sum of the first adaptive weight and the second adaptive weight is no greater than 1, obtain the multi-hypothesis probability being equal to the third probability.

13. The apparatus of claim 9, wherein the one or more processors are further configured to:
obtain the first adaptive weight from a set of predetermined weight values.

14. The apparatus of claim 13, wherein the one or more processors are further configured to:
obtain the set of predetermined weight values from a set of predetermined integer values divided by one constant value.

15. A non-transitory computer-readable storage medium for storing a bitstream to be decoded by the video decoding method comprising:
obtaining a first probability for one binary symbol from the bitstream according to a first adaptation parameter, wherein the one binary symbol is related to one given context model for a binary arithmetic decoder and the one binary symbol is from a plurality of binary symbols associated with the context model;
obtaining a second probability for the one binary symbol according to a second adaptation parameter;
obtaining a multi-hypothesis probability according to the first probability, a first adaptive weight, the second probability, and a second adaptive weight, wherein the multi-hypothesis probability determines a probability of the one binary symbol equaling to a binary value; and
decoding the one binary symbol according to the multi-hypothesis probability.

16. The non-transitory computer-readable storage medium of claim 15, wherein the method further comprises:
obtaining the first adaptive weight from a pre-defined range; and
obtaining the second adaptive weight from the pre-defined range.

17. The non-transitory computer-readable storage medium of claim 15, wherein the method further comprises:
independently obtaining the first adaptive weight and the second adaptive weight, wherein a sum of the first adaptive weight and the second adaptive weight meets one of following conditions:
the sum is equal to 1;
the sum is less than 1; or
the sum is greater than 1; and
wherein the obtaining of the multi-hypothesis probability according to the first probability, the first adaptive weight, the second probability, and the second adaptive weight comprises:
obtaining a third probability as a weighted combination of the first probability and the second probability according to the first adaptive weight and the second adaptive weight; and
obtaining the multi-hypothesis probability according to the third probability and the sum of the first adaptive weight and the second adaptive weight.

18. The non-transitory computer-readable storage medium of claim 17, wherein the obtaining of the multi-hypothesis probability according to the third probability and the sum of the first adaptive weight and the second adaptive weight comprises one of followings:
in response to determining that the sum of the first adaptive weight and the second adaptive weight is greater than 1, obtaining the multi-hypothesis probability by applying a right shift operation to the third probability;
in response to determining that the sum of the first adaptive weight and the second adaptive weight is greater than 1, obtaining the multi-hypothesis probability by dividing the third probability by a constant value; or
in response to determining that the sum of the first adaptive weight and the second adaptive weight is no greater than 1, obtaining the multi-hypothesis probability being equal to the third probability.

19. The non-transitory computer-readable storage medium of claim 15, wherein the method further comprises:
obtaining the first adaptive weight from a set of predetermined weight values.

20. The non-transitory computer-readable storage medium of claim 18, wherein the method further comprises:
obtaining the set of predetermined weight values from a set of predetermined integer values divided by one constant value.
